(19) United States
(12) Patent Application Publication
(10) Pub. No.: US 2024/0105214 A1
(43) Pub. Date: Mar. 28, 2024

(54) INFORMATION PROCESSING APPARATUS, NON-TRANSITORY COMPUTER READABLE MEDIUM, AND INFORMATION PROCESSING METHOD

(71) Applicant: FUJIFILM BUSINESS INNOVATION CORP., Tokyo (JP)

(72) Inventors: Tsutomu UDAKA, Kanagawa (JP); Minoru Akiyama, Kanagawa (JP)

(73) Assignee: FUJIFILM BUSINESS INNOVATION CORP., Tokyo (JP)

(21) Appl. No.: 18/158,773

(22) Filed: Jan. 24, 2023

(30) Foreign Application Priority Data
Sep. 22, 2022 (JP) 2022-151140

(51) Int. Cl. G10L 25/93; G10L 25/18; G10L 25/51

(52) U.S. Cl. CPC G10L 25/93; G10L 25/18; G10L 25/51

(57) ABSTRACT

An information processing apparatus includes a processor configured to: acquire first data indicative of a temporal change of an intensity of sound emitted by an apparatus; generate second data by extracting, from the first data, a maximum value in each section of a time width corresponding to temporal resolution at which human voice is unrecognizable and discarding values other than the maximum value; and transmit the second data to an external apparatus.

### CROSS-REFERENCE TO RELATED APPLICATIONS

This application is based on and claims priority under 35 USC 119 from Japanese Patent Application No. 2022-151140 filed Sep. 22, 2022.

### BACKGROUND

### (i) Technical Field

The present disclosure relates to an information processing apparatus, a non-transitory computer readable medium, and an information processing method.

### (ii) Related Art

A technique for detecting an abnormality of an apparatus by analyzing sound emitted by the apparatus while the apparatus is operating is known.

Japanese Patent No. 4810389 (Japanese Unexamined Patent Application Publication No. 2008-92358) discloses a system that includes a sound collecting unit that collects sound characteristics during operation of an image forming apparatus and a transmitting unit that transmits sound data to a remote place, and determines whether or not there is abnormal sound by comparing the sound data and normal sound data in the remote place.

In such a system, a user of an image forming apparatus and a person who analyzes sound of the image forming apparatus in a remote place are different in some cases. For example, a vendor of an image forming apparatus often analyzes sound of the image forming apparatus placed in a customer's facility by collecting sound of the image forming apparatus in a vendor's analysis device over a communication network.

Furthermore, in such a system, the sound collecting unit may collect sound around the image forming apparatus such as voice of conversation of a person. In a case where a user of the image forming apparatus and an analyzer who conducts analysis are different, transmitting sound collected by the sound collecting unit to an analyzer side as it is may undesirably lead to infringement of user's privacy.

There are following techniques for reducing a human voice component in a sound signal to be transmitted, for example, for the purpose of privacy protection.

Japanese Unexamined Patent Application Publication No. 2008-301529 discloses a system that makes it possible to know a situation in a remote place in real time without infringing privacy of a person in the place. In this system, a terminal apparatus in a target place collects sound in the place by a sound sensor and cuts a frequency band of conversion voice by performing processing such as filtering on an obtained sound signal. Then, the terminal apparatus transmits the processed sound to a place where a monitoring person is present.

Japanese Unexamined Patent Application Publication No. 10-322291 proposes an apparatus that can prevent eavesdropping of a person's conversation close to a sound data link. A sound signal detected by a sound sensor for the sound data link is transmitted to a destination after a large part of a signal component of human voice is attenuated by a filter.

### SUMMARY

Aspects of non-limiting embodiments of the present disclosure relate to a technique of transmitting information useful for analysis of abnormal sound to an external apparatus while preventing recognition of human voice from sound data transmitted from an information processing apparatus to the external apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: acquire first data indicative of a temporal change of an intensity of sound emitted by an apparatus; generate second data by extracting, from the first data, a maximum value in each section of a time width corresponding to temporal resolution at which human voice is unrecognizable and discarding values other than the maximum value; and transmit the second data to an external apparatus.

### BRIEF DESCRIPTION OF THE DRAWINGS

An exemplary embodiment of the present disclosure will be described in detail based on the following figures, wherein:

FIG. 1 illustrates a configuration of an information processing system according to an exemplary embodiment;

FIG. 2 illustrates a configuration of an image processing apparatus according to the exemplary embodiment;

FIG. 3 illustrates an overall procedure executed by the image processing apparatus to report abnormal sound;

FIG. 4 illustrates an example of a procedure of processing for generating time axis analysis data;

FIG. 5 is a view for explaining a spectrogram and a direction of analysis on the spectrogram;

FIG. 6 illustrates an example of time-series data of a sound intensity;

FIG. 7 illustrates an example of a procedure of processing for generating periodic abnormal sound analysis data;

FIG. 8 illustrates an example of the periodic abnormal sound analysis data;

FIG. 9 illustrates an example of a procedure of processing for generating frequency analysis data;

FIG. 10 illustrates an example of operation information of the image processing apparatus;

FIG. 11 illustrates an example of a procedure of processing for incorporating the operation information into abnormal sound report data; and

FIG. 12 illustrates a hardware configuration of a computer.

### DETAILED DESCRIPTION

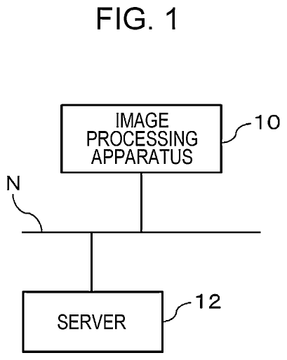

An information processing system according to an exemplary embodiment is described with reference to FIG. 1. FIG. 1 is a block diagram illustrating an example of a configuration of the information processing system according to the exemplary embodiment.

The information processing system according to the exemplary embodiment includes an image processing apparatus 10 and a server 12. The information processing system may include plural image processing apparatuses 10 and plural servers 12.

The image processing apparatus 10 and the server 12 have a function of communicating with another apparatus. The communication may be wired communication using a cable or may be wireless communication. The wireless communication is, for example, near-field wireless communication, Wi-Fi (Registered Trademark), or the like. The wireless communication may be wireless communication based on a standard other than these standards. For example, the image processing apparatus 10 and the server 12 may communicate with another apparatus over a communication path N such as a local area network (LAN) or the Internet.

The image processing apparatus 10 is an example of an information processing apparatus and has, for example, at least one of a print function, a scan function, and a copy function. The image processing apparatus 10 is a printer, a scanner, a copier, a multifunction printer (e.g., an apparatus that has functions such as a print function, a scan function, and a copy function), or the like.

The server 12 is an example of an external apparatus and analyzes sound emitted by an apparatus such as the image processing apparatus 10. The image processing apparatus 10 determines whether or not abnormal sound has occurred by analyzing sound data of sound emitted by the image processing apparatus 10, and in a case where abnormal sound has occurred, generates abnormal sound report data indicative of characteristics of the abnormal sound and transmits the abnormal sound report data to the server 12. The abnormal sound is sound that is not emitted during normal operation of the image processing apparatus 10 (i.e., while the image processing apparatus 10 is operating normally). The abnormal sound is information for specifying a failure or a trouble occurring in the image processing apparatus 10. The server 12 determines a cause of occurrence of the abnormal sound (e.g., a component in which the failure has occurred) by analyzing the abnormal sound report data.

For example, a business operator who provides an apparatus may offer a service of detecting an abnormality of an apparatus such as the image processing apparatus 10 placed in a customer's place by analyzing sound emitted by the apparatus and addressing the abnormality. In this case, the server 12 is used for the service.

Although the image processing apparatus 10 is illustrated as an apparatus whose sound is to be analyzed in the example illustrated in FIG. 1, the apparatus whose sound is to be analyzed is not limited to the image processing apparatus 10 and may be an apparatus different from the image processing apparatus 10.

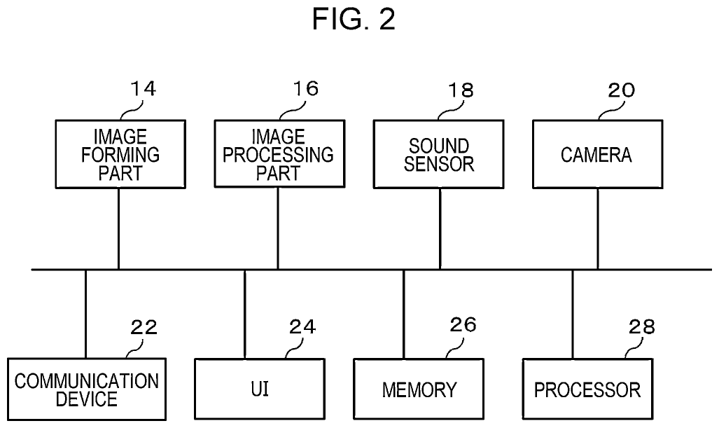

A configuration of the image processing apparatus 10 is described below with reference to FIG. 2. FIG. 2 illustrates an example of the configuration of the image processing apparatus 10.

The image processing apparatus 10 includes an image forming part 14, an image processing part 16, a sound sensor 18, a camera 20, a communication device 22, a user interface (UI) 24, a memory 26, and a processor 28.

The image forming part 14 has, for example, at least one of a print function, a scan function, and a copy function. For example, the image forming part 14 may print image data, may generate image data by optically reading a document, or may print the image data thus read.

The image processing part 16 performs image processing on image data. The image processing is, for example, compression processing, decompression processing, character recognizing processing (e.g., OCR), or the like. The image data on which the image processing is performed may be generated, for example, by the scan function of the image processing apparatus 10 or may be transmitted to the image processing apparatus 10 from an apparatus different from the image processing apparatus 10.

The sound sensor 18 detects sound emitted by the image processing apparatus 10 and generates sound data of the detected sound. The sound sensor 18 is, for example, disposed at one or more positions inside a housing of the image processing apparatus 10 or on an outer circumference of the image processing apparatus 10. The sound sensor 18 may be disposed around the image processing apparatus 10 and collect sound emitted by the image processing apparatus 10 or sound around the image processing apparatus 10.

The sound data generated by the sound sensor 18 is data indicative of a temporal change of an intensity of sound detected by the sound sensor 18. That is, the sound data includes a value of an intensity of sound detected at each sampling time at which the sound sensor 18 samples sound.

The camera 20 photographs surroundings of the image processing apparatus 10. As a result of the photographing, image data of surroundings of the image processing apparatus 10 is generated. The camera 20 may be disposed around the image processing apparatus 10 and photograph surroundings of the image processing apparatus 10 instead of being disposed on the image processing apparatus 10 itself.

The communication device 22 includes one or more communication interfaces having a communication chip, a communication circuit, or the like and has a function of transmitting information to another apparatus and a function of receiving information from another apparatus. The communication device 22 may have a wireless communication function such as a near-field wireless communication or Wi-Fi or may have a wired communication function.

The UI 24 is a user interface and includes a display and an input device. The display is a liquid crystal display or an EL display. The input device is a keyboard, a mouse, an input key, an operation panel, or the like. The UI 24 may be a UI such as a touch panel that serves as both a display and an input device.

The memory 26 is a device that constitutes one or more storage regions in which data is stored. The memory 26 is, for example, a hard disk drive (HDD), a solid state drive (SSD), any of various memories (e.g., a RAM, a DRAM, an NVRAM, a ROM), any of other storage devices (e.g., an optical disc), or a combination thereof.

The processor 28 controls operation of each part of the image processing apparatus 10. Furthermore, the processor 28 performs information processing such as recording and editing of operation information of the image processing apparatus 10, detection of occurrence of abnormal sound, and report of abnormal sound to the server 12.

An example of a procedure of processing performed by the processor 28 to report abnormal sound is described below with reference to a flowchart.

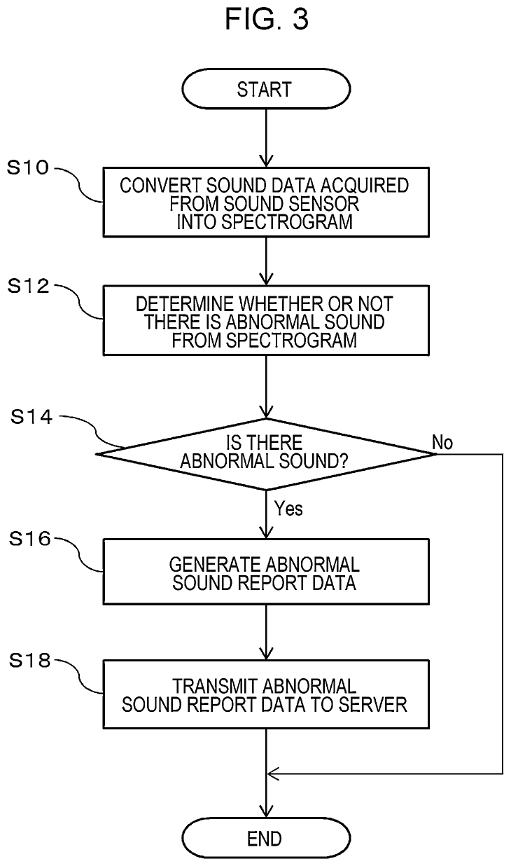

FIG. 3 illustrates an example of overall processing performed by the processor 28 to report abnormal sound.

In this procedure, first, the processor 28 converts sound data acquired from the sound sensor 18 into a spectrogram (S10). The spectrogram is, for example, three-dimensional data of a time, a frequency, and an intensity. For example, in a case where the time is expressed by the horizontal axis, the frequency is expressed by the vertical axis, and the intensity of sound is expressed by luminance (or a density), the spectrogram is a two-dimensional gray-scale image. The conversion processing in S10 may be performed, for example, by using a known arithmetic algorithm for calculating a spectrogram, such as short-time Fourier transform (STFT).

Every time sound data for a period of a predetermined length (in other words, sound data of predetermined data amount) is accumulated in a buffer memory (which is, for example, secured in the memory 26), the processing in FIG. 3 is started, and a spectrogram is calculated from the sound data in the buffer memory in S10.

Next, the processor 28 determines whether or not there is abnormal sound from the spectrogram (S12).

This determination is, for example, performed by using a machine learning engine. The machine learning engine may be, for example, an autoencoder. The autoencoder used in this case is one that is trained by using spectrograms of various samples of normal sound emitted by the image processing apparatus 10. That is, the autoencoder is one that is trained so that when a spectrogram image of normal sound is input to an input layer, an image as close to the input image as possible is output from an output layer. Accordingly, in a case where a spectrogram image of normal sound is given as input, the trained autoencoder outputs an image very similar to the input. Meanwhile, in a case where a spectrogram image of sound that is not normal is given as input, the trained encoder outputs an image markedly different from the input.

In the determination in S12, the spectrogram image obtained in S10 is input to the trained autoencoder, and a difference between an image that is output in response to this by the autoencoder and the input image is obtained for each pixel. In a case where a total sum of differences obtained for the pixels is equal to or smaller than a predetermined threshold value, the output image is similar to the input image, and it is therefore determined that the input image is a spectrogram image of normal sound. On the other hand, in a case where the total sum of differences obtained for the pixels is larger than the threshold value, the output image is not similar to the input image, and it is therefore determined that the input image does not indicate normal sound, that is, indicates sound including abnormal sound.

The autoencoder used in this example may be mounted as software or may be mounted by using a hardware circuit such as a processor for artificial intelligence (AI).

Note that use of the autoencoder is merely an example. A method different from the method using the autoencoder may be used for the determination in S12.

Next, the processor 28 determines whether or not a result of the determination in S12 indicates that “there is abnormal sound” (S14). In a case where the result of the determination is No, the sound data acquired in S10 is sound data of sound during a normal state of the image processing apparatus 10, and therefore the processor 28 finishes processing concerning this sound data without transmitting abnormal sound report data to the server 12.

In a case where the result of the determination in S12 is Yes, the processor 28 generates abnormal sound report data by using the spectrogram obtained in S10 (S16) and transmits the abnormal sound report data to the server 12 (S18).

The abnormal sound report data generated in S16 includes data indicative of characteristics of abnormal sound included in the sound data acquired in S10. The abnormal sound report data may further include information that can be used for analysis of a cause of the abnormal sound such as operation information of the image processing apparatus 10 during a same period as a sampling period of the sound data.

It is also possible to transmit, as the data indicative of characteristics of the abnormal sound, the sound data itself acquired in S10 or the spectrogram obtained by the conversion in S10 to the server 12. However, sound that is audible to humans can be reproduced from these data, and information related to a secret of the user of the image processing apparatus 10 such as voice of a person close to the image processing apparatus 10 is transmitted to the server 12. Such a situation may lead to a risk that an operator of the server 12 is believed to be eavesdropping on the user of the image processing apparatus 10.

To avoid such a risk, data that has been processed so that human voice cannot be reproduced is used as the data indicative of characteristics of abnormal sound in the present exemplary embodiment.

In the present exemplary embodiment, time-series data indicative of a temporal change of an intensity of sound emitted by the image processing apparatus 10 is transmitted to the server 12 as one of the data indicative of characteristics of abnormal sound, and this data is processed into data of resolution that is rough to such an extent that human voice is unrecognizable. In general, a lower-limit frequency of human voice is approximately 120 Hz. For example, in a case where the data is processed into data of resolution of 200 Hz or less (i.e., 5 milliseconds or more in terms of temporal resolution), it is very difficult to reproduce audible human voice from the data. Such data obtained by processing time-series data of an intensity of sound emitted by the image processing apparatus 10 to have resolution that is rough to such an extent that human voice is unrecognizable is hereinafter referred to as time axis analysis data.

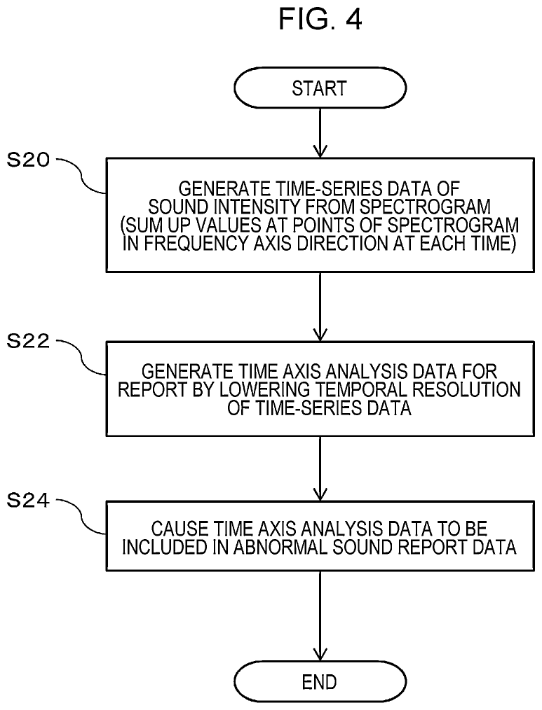

FIG. 4 illustrates an example of a procedure for generating the time axis analysis data included in the abnormal sound report data generated in S16.

In this procedure, the processor 28 generates time-series data of an intensity of sound of the image processing apparatus 10 from the spectrogram obtained by the conversion in S10 (S20). Since abnormal sound report data is not generated in a case where the spectrogram indicates normal sound, S20 is executed in a case where it is determined in S14 of the procedure of FIG. 3 that the spectrogram indicates that there is abnormal sound. That is, the time-series data generated in S20 is generated from the spectrogram for which it is determined that there is abnormal sound.

In S20, the processor 28 sums up values at points of an image of the spectrogram in a frequency direction at each time. The sum at each time indicates an intensity of sound at the time.

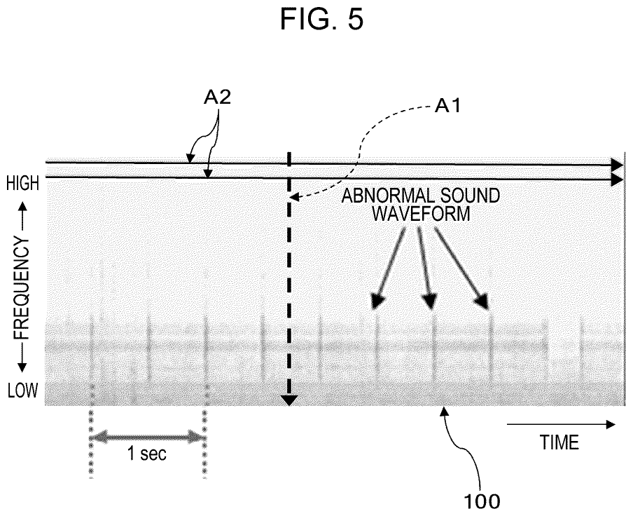

FIG. 5 illustrates an example of an image 100 of a spectrogram. The horizontal axis of this image indicates a time, and the vertical axis of this image indicates a frequency. A density at each point of the image indicates an intensity of a frequency component corresponding to the point at a time corresponding to the point. A point of a higher density of black indicates a higher intensity. In S20, at each time of the image 100, densities at frequency points at the time are summed up along a frequency direction, that is, a direction indicated by arrow A1 in FIG. 5 to find an intensity of sound at the time. Accordingly, temporal resolution of the generated time-series data is identical to temporal resolution of the spectrogram.

Since the temporal resolution of the spectrogram obtained in S10 is larger than a sampling interval of the sound sensor 18, the temporal resolution of the time-series data obtained in S20 is rougher than temporal resolution of the sound data output by the sound sensor 18.

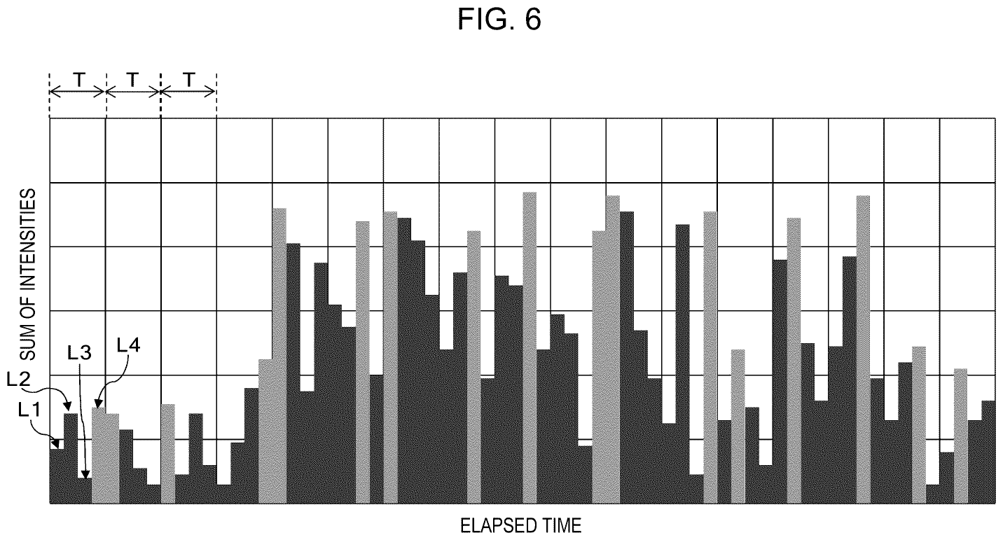

FIG. 6 illustrates an example of time-series data of a sound intensity generated in S20. In the example of FIG. 6, time-series data of sound is expressed as a bar graph whose horizontal axis indicates a time and whose vertical axis indicates an intensity of sound (a sum of frequency values at the same time). In FIG. 6, for convenience of description, the time of the horizontal axis is divided into sections of a predetermined length. The length T of this section is a length decided in accordance with temporal resolution at which human voice is unrecognizable. In a case where the temporal resolution is, for example, 200 Hz or less, the length T of the section is a predetermined value of 5 milliseconds or more. The illustrated time-series data includes four pieces of intensity data in each section of the length T. For example, four pieces of intensity data L1, L2, L3, and L4 are arranged in this order in an earliest section (i.e., a leftmost section in FIG. 6) within the illustrated range.

Next, the processor 28 generates time axis analysis data to be transmitted to the server 12 by lowering the temporal resolution of the time-series data (S22). In S22, the processor 28 generates time axis analysis data by extracting, for each section of the length T of the time-series data, data of a maximum value among the pieces of intensity data in the section and discarding remaining pieces of data.

In the example of FIG. 6, in S22, the processor 28 extracts, for each section, only a maximum value (indicated by a bar graph of a lower density than the other three in the same section in FIG. 6) among the four pieces of data in the section. In the earliest section, the maximum value L4 among the four pieces of intensity data L1, L2, L3, and L4 is extracted.

The time axis analysis data thus generated has one piece of data for each section of the length T. Since the length T is equal to or more than a time width corresponding to temporal resolution at which human voice is unrecognizable, it is impossible or very difficult to recognize human voice from the time axis analysis data.

Furthermore, since the time axis analysis data includes, for each section of the length T, information on a maximum value in the section, a large part of information on abnormal sound included in the original time-series data is saved in the time axis analysis data. In a case where abnormal sound is occurring in a section, it is highly likely that a maximum value in the section includes information on the abnormal sound. Conversely, for example, according to a method of averaging time-series data for each section of the length T or a method using a low-pass filter, there is a possibility that information on abnormal sound, which is strong but short, becomes missing or is weakened. On the other hand, according to the method of leaving a maximum value for each section according to the present exemplary embodiment, such missing or the like is less likely to occur.

The time axis analysis data may be used for analysis of a cause of abnormal sound occurring irregularly or abnormal sound occurring sporadically, for example, by being combined with operation information, which will be described later.

The processor 28 causes the time axis analysis data generated in S22 to be included in the abnormal sound report data to be transmitted to the server 12 (S24).

Next, another example of information of abnormal sound transmitted to the server 12 by the processor 28 is described. In this example, the processor 28 transmits periodic abnormal sound analysis data to the server 12.

The time axis analysis data described above may be used for analysis of abnormal sound occurring irregularly or abnormal sound occurring sporadically. However, it is difficult to detect periodic abnormal sound (e.g., especially, periodic abnormal sound of a low intensity) from this data. In view of this, the processor 28 generates periodic abnormal sound analysis data including information on periodic abnormal sound from a spectrogram.

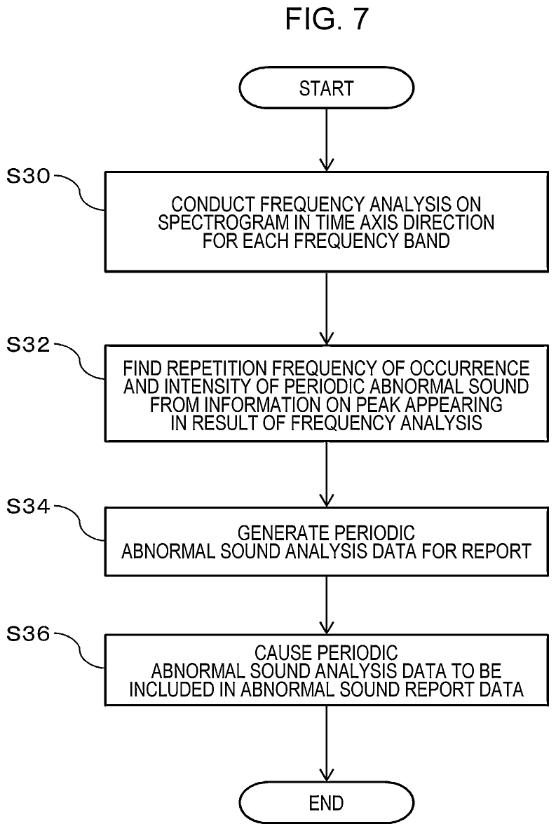

For this purpose, the processor 28 conducts, for each frequency band, frequency analysis in a time axis direction on the spectrogram generated in S10 of the procedure of FIG. 2, as illustrated in FIG. 7 (S30). See the image 100 of the spectrogram illustrated in FIG. 5. In the analysis in S30, frequency analysis is conducted on the image 100 of the spectrogram along a direction indicated by arrow A2. In S30, for example, frequency analysis is conducted in the time axis direction on a sequence of values at points indicative of a temporal change in each frequency band in the spectrogram.

The analysis conducted in S30 is hereinafter referred to as repetition occurrence frequency analysis. A result of the repetition occurrence frequency analysis is a graph on a two-dimensional space made up of two axes, specifically, a frequency axis and an intensity axis.

In a case where a periodic abnormal sound waveform appears in the image 100 of the spectrogram, a peak appears at a position of a repetition occurrence frequency of the abnormal sound waveform in a result of the repetition occurrence frequency analysis. Information on this peak, that is, information on the repetition occurrence frequency and an intensity may be used for detection of a trouble causing periodic abnormal sound.

The processor 28 performs, for each frequency band of the spectrogram, the following processing in S32 and S34 on a result of the repetition occurrence frequency analysis conducted on the frequency band.

Specifically, the processor 28 finds, for each peak appearing in the result of the repetition occurrence frequency analysis, a position on the frequency axis (i.e., a value of a repetition frequency) and a position on the intensity axis (i.e., a value of an intensity) (S32). Then, the processor 28 extracts remarkable one from among pieces of information (i.e., a repetition occurrence frequency and an intensity) on the peaks thus found and generates periodic abnormal sound analysis data indicative of the information on a remarkable peak (S34). In S34, for example, the processor 28 extracts information on a predetermined number of peaks that rank high in a descending order of intensity from among peaks appearing in the result of the repetition occurrence frequency analysis conducted on the frequency band. However, this is merely an example. Alternatively, for example, the processor 28 may extract, as remarkable peaks, all peaks having an intensity equal to or higher than a predetermined threshold value. The threshold value may be determined for each frequency band. These are examples of a predetermined condition that needs to be met by a remarkable peak.

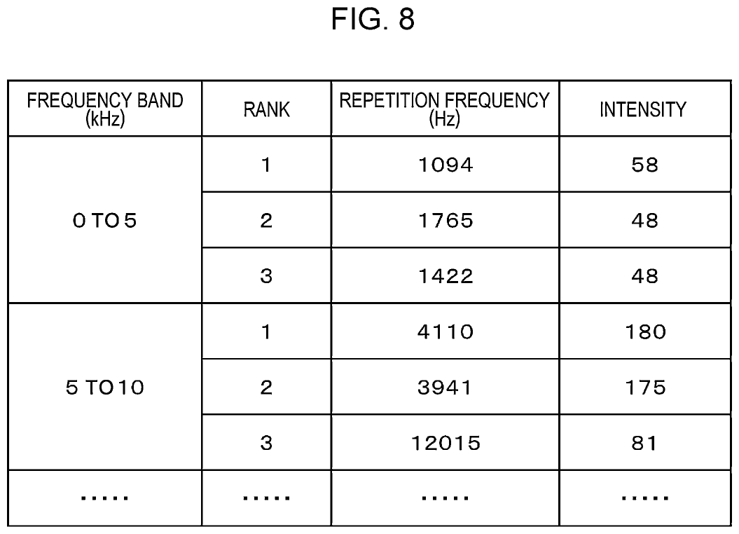

FIG. 8 illustrates an example of the periodic abnormal sound analysis data generated in S34. In the example of FIG. 8, the periodic abnormal sound analysis data includes, for each frequency band of the spectrogram, values of repetition occurrence frequencies and intensities of three peaks whose intensities appearing in the result of the repetition occurrence frequency analysis (S30) conducted on the band rank first, second, and third.

The processor 28 causes the generated periodic abnormal sound analysis data to be included in the abnormal sound report data to be transmitted to the server 12 (S36). In this way, in S18 of the procedure of FIG. 3, the periodic abnormal sound analysis data is transmitted to the server 12 together with other data such as the time axis analysis data.

In the procedure of FIG. 7, the repetition occurrence frequency analysis is conducted in the time axis direction for each frequency band of the spectrogram, and therefore information indicating in which frequency band of the original sound data periodic abnormal sound is occurring is obtained. Then, information on periodic abnormal sound in each frequency band, that is, information on a peak in a result of the repetition occurrence frequency analysis is provided to the server 12.

Next, still another example of information on abnormal sound transmitted to the server 12 by the processor 28 is described. In this example, the processor 28 transmits frequency analysis data to the server 12.

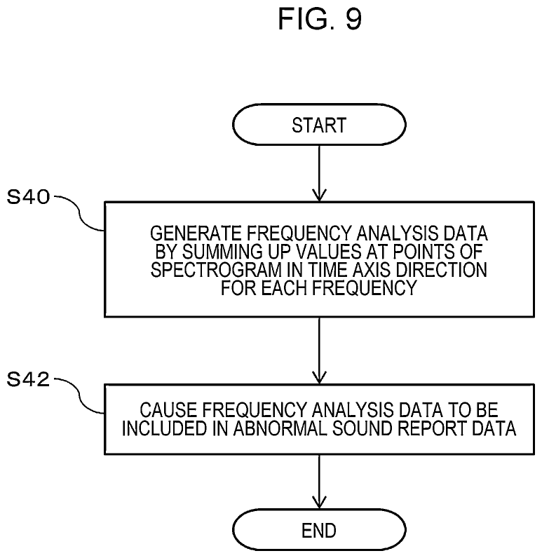

In this example, the processor 28 executes, for example, the procedure illustrated in FIG. 9. In this procedure, the processor 28 generates frequency analysis data by summing up, for each frequency, values of points of the spectrogram obtained in S10 of the procedure of FIG. 3 in the time axis direction (the direction indicated by arrow A2 in FIG. 5) (S40). The sum obtained for each frequency of the spectrogram represents an intensity of sound at the frequency. That is, the frequency analysis data generated in S40 indicates information substantially identical to a result of frequency analysis conducted on sound data output by the sound sensor 18. However, since the frequency analysis data in S40 is generated from the spectrogram, resolution in the frequency axis direction is equal to that of the spectrogram.

The frequency analysis data generated in S40 indicates which frequency component of sound emitted by the image processing apparatus 10 is remarkable, and therefore may be used for analysis of a cause of continuous abnormal sound.

The processor 28 causes the generated frequency analysis data to be included in the abnormal sound report data (S42). In this way, in S18 of the procedure of FIG. 3, the frequency analysis data is transmitted to the server 12 together with other data such as the time axis analysis data.

The processor 28 may transmit operation information of the image processing apparatus 10 to the server 12 in addition to the various kinds of analysis data illustrated above.

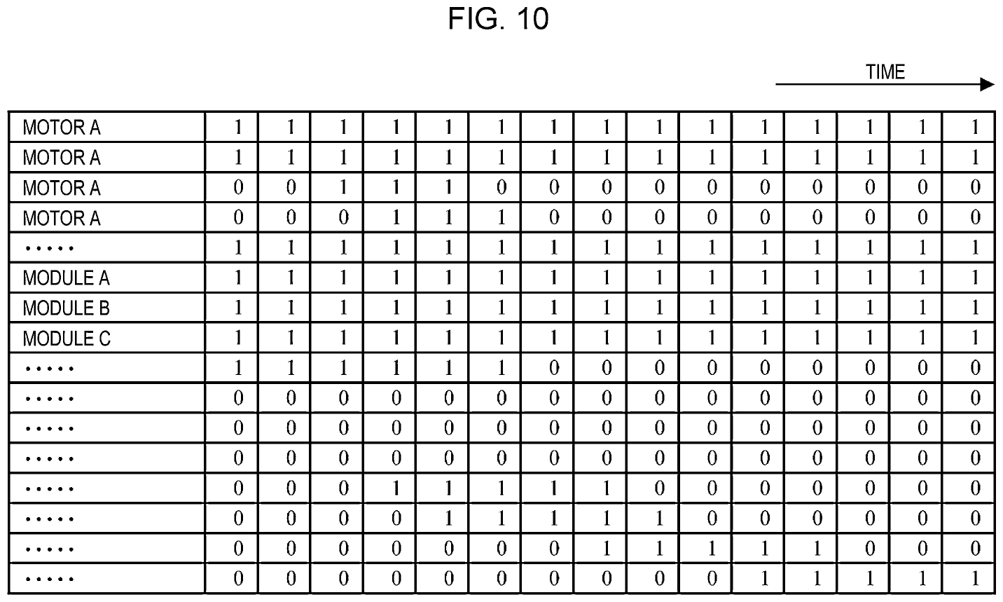

The operation information is information indicative of an operation state of each part of the image processing apparatus 10 at each time. FIG. 10 illustrates an example of operation information recorded by the processor 28.

The horizontal axis of the operation information illustrated in a table format in FIG. 10 represents a time. Each row of the operation information represents a component that constitutes the image processing apparatus 10. The horizontal axis of the operation information is divided every predetermined period into sections of respective sampling times. That is, each column of the operation information represents an individual sampling time. In a cell at a position where a row and a column intersect, a value indicative of whether or not a component corresponding to the row is operating at a sampling time corresponding to the column is recorded. In the example illustrated in FIG. 10, a value “1” is recorded in a case where a component is operating, and a value “0” is recorded in a case where a component is not operating.

The processor 28 determines whether or not each component is operating, for example, at each sampling time every predetermined time while controlling the image processing apparatus 10 and records a result of the determination in operation information. For example, the processor 28 determines whether or not each component is operating by a known method on the basis of an operation command issued for the component by the processor 28 or a signal of a sensor that detects whether or not the component is operating. The operation information is held in the memory 26 or in a non-volatile storage device omitted in FIG. 2.

Although the operation information is expressed in a table format in FIG. 10, the format of the operation information is not limited to this. Any format may be employed as long as information of similar contents can be expressed.

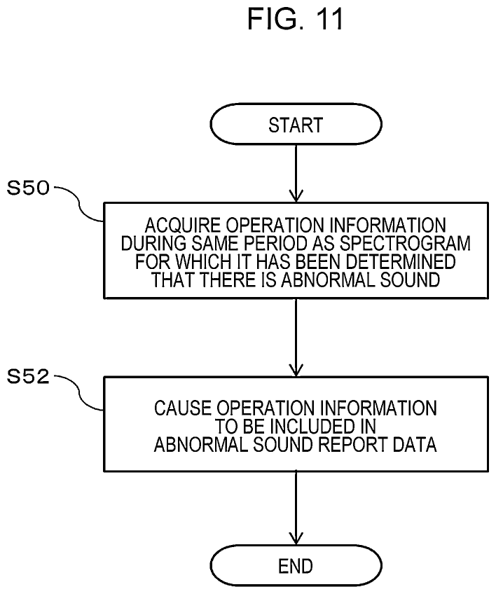

When the abnormal sound report data is generated in S16 of the procedure of FIG. 3, the processor 28 executes the procedure illustrated in FIG. 11. Specifically, the processor 28 acquires, from the memory or the non-volatile storage device, operation information during a same period as a period of detection of sound data from which the spectrogram found to have abnormal sound in the determination in S14 was generated (S50). Then, the processor 28 causes the operation information thus acquired to be included in the abnormal sound report data (S52). In this way, in S18 of the procedure of FIG. 3, the operation information is transmitted to the server 12 together with the analysis data such as the time axis analysis data.

Note that not all of the time axis analysis data, the periodic abnormal sound analysis data, the frequency analysis data, and the operation information need be included in the abnormal sound report data transmitted to the server 12 by the processor 28. The processor 28 need just generate abnormal sound report data including at least one piece of data or information necessary for analysis among these pieces of data and information. Furthermore, the abnormal sound report data may include data different from the data illustrated above.

The server 12 that has received the abnormal sound report data from the image processing apparatus 10 analyzes, for example, a cause of abnormal sound indicated by the abnormal sound report data.

For example, the server 12 specifies a component that causes the abnormal sound by checking the time axis analysis data and the operation information included in the abnormal sound report data against each other. In this specifying processing, for example, the server 12 specifies, for each section of the time axis analysis data, a component operating in the section from the operation information. In a case where an intensity of sound in the section of the time axis analysis data is remarkably higher than an intensity of sound emitted by the specified component during normal operation (for example, by a predetermined amount), it is determined that this component is likely to be a cause of the abnormal sound. Note that estimating a cause of abnormal sound by checking time-series data of an intensity of sound of the image processing apparatus 10 against the operation information is a conventionally used method, and therefore this conventional method may also be used in this example.

The server 12 specifies a component that is emitting periodical abnormal sound from the periodic abnormal sound analysis data (see FIG. 8) by a known analysis method. The server 12 specifies a component that is emitting continuous abnormal sound from the frequency analysis data by a known analysis method.

The exemplary embodiment of the present disclosure and modifications thereof have been described above. The exemplary embodiment and modifications are merely illustrative and can be modified or improved in various ways within the scope of the present disclosure.

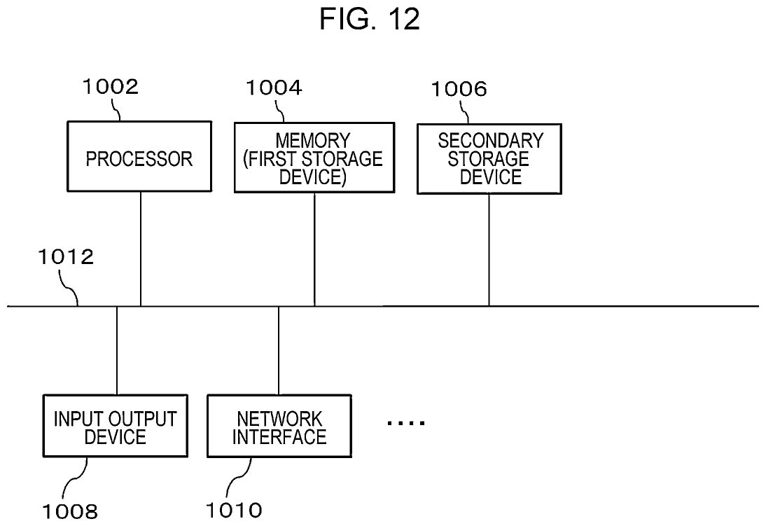

An information processing mechanism of the image processing apparatus according to the above exemplary embodiment is, for example, a general-purpose computer. This computer has, for example, a circuit configuration in which members such as a processor 1002, a memory (first storage device) 1004 such as a random access memory (RAM), a controller that controls a secondary storage device 1006, which is a non-volatile storage device such as a flash memory, a solid state drive (SSD), or a hard disk drive (HDD), an interface with various input image output devices 1008, a network interface 1010 that performs control for connection with a network such as a local area network are connected through a data transmission path such as a bus 1012, as illustrated in FIG. 12. A program describing contents of the processing of the above exemplary embodiment is installed in the computer over a network or the like and is stored in the secondary storage device 1006. The program stored in the secondary storage device 1006 is executed by using the memory 1004 by the processor 1002, and thereby the information processing mechanism according to the present exemplary embodiment is configurated.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

Although a case where the illustrated processing procedures are performed by the single processor 28 has been described in the above exemplary embodiment for convenience of description, this is merely an example. Alternatively, the illustrated processing procedures may be performed by plural processors 28 in cooperation. In this case, the processor 28 may be provided for each role. Examples of such processors 28 include a processor that converts sound data output by the sound sensor 18 into a spectrogram, an AI processor that determines whether or not the spectrogram represents abnormal sound, and a processor that generates time-series data of a sound intensity or frequency analysis data by processing the spectrogram.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing apparatus including:
a processor configured to:
   acquire first data indicative of a temporal change of an intensity of sound emitted by an apparatus;
   generate second data by extracting, from the first data, a maximum value in each section of a time width corresponding to temporal resolution at which human voice is unrecognizable and discarding values other than the maximum value; and
   transmit the second data to an external apparatus.
      (((2)))

The information processing apparatus according to (((1))), wherein
the processor is configured to:
   determine from a spectrogram of sound emitted by the apparatus whether or not sound expressed by the spectrogram is sound during a normal state of the apparatus; and
   generate the first data from the spectrogram in a case where it is determined that the sound expressed by the spectrogram is not sound during the normal state.
      (((3)))

The information processing apparatus according to (((2))), wherein
the processor is further configured to:
   conduct repetition occurrence frequency analysis on the spectrogram in a time axis direction;
find a peak of an intensity that meets a predetermined condition from a result of the repetition occurrence frequency analysis and generate third data indicative of a repetition occurrence frequency and an intensity of the peak thus found; and
   transmit the third data to the external apparatus in association with the second data.
      (((4)))

The information processing apparatus according to (((2))) or (((3))), wherein
the processor is further configured to:
   generate, from the spectrogram, fourth data indicative of a distribution of intensities of sound at frequencies in the spectrogram; and
   transmit the fourth data to the external apparatus in association with the second data.
      (((5)))

A program causing a computer to execute a process, the process including:
acquiring first data indicative of a temporal change of an intensity of sound emitted by an apparatus;
generating second data by extracting, from the first data, a maximum value in each section of a time width corresponding to temporal resolution at which human voice is unrecognizable and discarding values other than the maximum value; and
transmitting the second data to an external apparatus.

What is claimed is:

1. An information processing apparatus comprising:
a processor configured to:
acquire first data indicative of a temporal change of an intensity of sound emitted by an apparatus;
generate second data by extracting, from the first data, a maximum value in each section of a time width corresponding to temporal resolution at which human voice is unrecognizable and discarding values other than the maximum value; and
transmit the second data to an external apparatus.

2. The information processing apparatus according to claim 1, wherein
the processor is configured to:
determine from a spectrogram of sound emitted by the apparatus whether or not sound expressed by the spectrogram is sound during a normal state of the apparatus; and
generate the first data from the spectrogram in a case where it is determined that the sound expressed by the spectrogram is not sound during the normal state.

3. The information processing apparatus according to claim 2, wherein
the processor is further configured to:
conduct repetition occurrence frequency analysis on the spectrogram in a time axis direction;
find a peak of an intensity that meets a predetermined condition from a result of the repetition occurrence frequency analysis and generate third data indicative of a repetition occurrence frequency and an intensity of the peak thus found; and
transmit the third data to the external apparatus in association with the second data.

4. The information processing apparatus according to claim 2, wherein
the processor is further configured to:
generate, from the spectrogram, fourth data indicative of a distribution of intensities of sound at frequencies in the spectrogram; and
transmit the fourth data to the external apparatus in association with the second data.

5. A non-transitory computer readable medium storing a program causing a computer to execute a process, the process comprising:
acquiring first data indicative of a temporal change of an intensity of sound emitted by an apparatus;
generating second data by extracting, from the first data, a maximum value in each section of a time width corresponding to temporal resolution at which human voice is unrecognizable and discarding values other than the maximum value; and
transmitting the second data to an external apparatus.

6. An information processing method comprising:
acquiring first data indicative of a temporal change of an intensity of sound emitted by an apparatus;
generating second data by extracting, from the first data, a maximum value in each section of a time width corresponding to temporal resolution at which human voice is unrecognizable and discarding values other than the maximum value; and
transmitting the second data to an external apparatus.
